(19) United States
(12) Patent Application Publication
(10) Pub. No.: US 2008/0245857 A1
(43) Pub. Date: Oct. 9, 2008

(54) BOOKMARK TRANSACTION CARD

(76) Inventors: Karie Lazarowicz, Minneapolis, MN (US); Tim D. Schumann, Arden Hills, MN (US)

Correspondence Address: TARGET BRANDS, INC., 1000 NICOLLET MALL, TPS-3165, MINNEAPOLIS, MN, 55403, US

(21) Appl. No.: 11/697,278

(22) Filed: Apr. 5, 2007

(51) Int. Cl. G06K 5/00

(52) U.S. Cl. 235/380

(57) ABSTRACT

A financial transaction card includes a substantially planar substrate and a cut formed through the substantially planar substrate. The substantially planar substrate includes an account identifier linking the financial transaction card to at least one of a financial account and a financial record, and the account identifier is machine readable by a point-of-sale terminal. The cut defines a boundary between a first portion and a second portion of the substantially planar substrate. The first portion of the substantially planar substrate is configured to flex relative to the second portion of the substantially planar substrate, and the first portion is biased toward the second portion to receive and secure one or more sheets of paper between the first portion and the second portion of the substantially planar substrate. Stored-value card assemblies, methods of encouraging purchase and facilitating use of a stored-value card, and other embodiments are also disclosed.

### BACKGROUND OF THE INVENTION

Stored-value cards and financial transaction cards come in many forms. A gift card, for example, is a type of stored-value card that includes a pre-loaded or selectively loaded monetary value. In one example, a consumer buys a gift card having a specified value for presentation as a gift to another person. In another example, a consumer is offered a gift card as an incentive to make a purchase. A gift card, like other stored-value cards, can be “recharged” or “reloaded” at the direction of the bearer. The balance associated with the gift card declines as the gift card is used, encouraging repeat visits to the retailer or other provider issuing the gift card. Additionally, the gift card generally remains in the user's purse or wallet, serving as an advertisement or reminder to revisit the associated retailer. Gift cards and other stored-value cards provide a number of advantages to both the consumer and the retailer.

### SUMMARY OF THE INVENTION

One aspect of the present invention relates to a financial transaction card including a substantially planar substrate and a cut formed through the substantially planar substrate. The substantially planar substrate includes an account identifier linking the financial transaction card to at least one of a financial account and a financial record, and the account identifier is machine readable by a point-of-sale terminal. The cut defines a boundary between a first portion and a second portion of the substantially planar substrate. The first portion of the substantially planar substrate is configured to flex relative to the second portion of the substantially planar substrate, and the first portion is biased toward the second portion such that the financial transaction card is configured to receive and secure one or more sheets of paper between the first portion and the second portion of the substantially planar substrate. Methods of encouraging purchase and facilitating use of a stored-value card, and other embodiments of stored-value or financial transaction cards and associated assemblies are also disclosed.

### BRIEF DESCRIPTION OF THE DRAWINGS

Embodiments of the invention will be described with respect to the figures, in which like reference numerals denote like elements, and in which:

FIG. 1 is a perspective view illustration of a stored-value card, according to one embodiment of the present invention.

FIG. 2 is a front view illustration of the stored-value card of FIG. 1.

FIG. 3 is a rear view illustration of the stored-value card of FIG. 1.

FIG. 4 is a top view illustration of the stored-value card of FIG. 1, the bottom view being a mirror image of the top view.

FIG. 5 is a right side view illustration of the stored-value card of FIG. 1, the left side view being a mirror image of the right side view.

FIG. 6A is a cross-sectional view illustration of the stored-value card taken along the line 6A-6A as indicated in FIG. 2 with a first portion of the stored-value card in a first position, according to one embodiment of the present invention.

FIG. 6B is a cross-sectional view illustration similar to FIG. 6A, but with the first portion in a second position, according to one embodiment of the present invention.

FIG. 7 is a front view illustration of the stored-value card of FIG. 1 being used as a bookmark, according to one embodiment of the present invention.

FIGS. 8A-8I are each a front view illustration of a stored-value card, according to embodiments of the present invention.

FIG. 9 is a front view illustration of a backer, according to one embodiment of the present invention.

FIG. 10 is a rear view illustration of a stored-value card assembly including the backer of FIG. 9 and the stored-value card of FIG. 1, according to one embodiment of the present invention.

FIG. 11 is a flow chart illustrating a method of encouraging purchase and facilitating use of a stored-value card, according to one embodiment the present invention.

FIG. 12 is a flow chart illustrating a method of using a stored-value card, according to one embodiment of the present invention.

### DETAILED DESCRIPTION

A stored-value card or financial transaction product is adapted for making purchases of goods and/or services at, for example, a retail store or website. According to one embodiment, an original consumer buys a stored-value card to give a recipient who in turn is able to use a monetary value associated with the stored-value card at a retail store or setting to pay for goods and/or services. In one embodiment, the stored-value card provides for prepaid calling minutes, points, or other non-monetary measure of value such that the minutes or points in an account associated with the stored-value card can be applied toward a telephone call, purchase, etc. A stored-value card, according to embodiments of the present invention, provides the consumer and/or recipient with an auxiliary use in addition to the ability to pay for goods and/or services or to accessing calling minutes, points, etc. with the stored-value card.

In particular, the stored-value card includes a slit or cut defining a tab or first portion deflectable relative to the remainder of the stored-value card to receive one or more pages of a book, magazine, or other publication therebetween. As such, the stored-value card is configured to function as a bookmark. The stored-value card includes a necessary identifier or other device linking the stored-value card to an account or record such that the stored-value card can be used toward the purchase of one or more of goods and services, toward the use of calling minutes, etc. In one embodiment, this dual functional aspect (e.g., for use toward purchases and use as a bookmark) of the stored-value card promotes the sale, use, and/or loading of the stored-value card by potential consumers and/or bearers of the stored-value card.

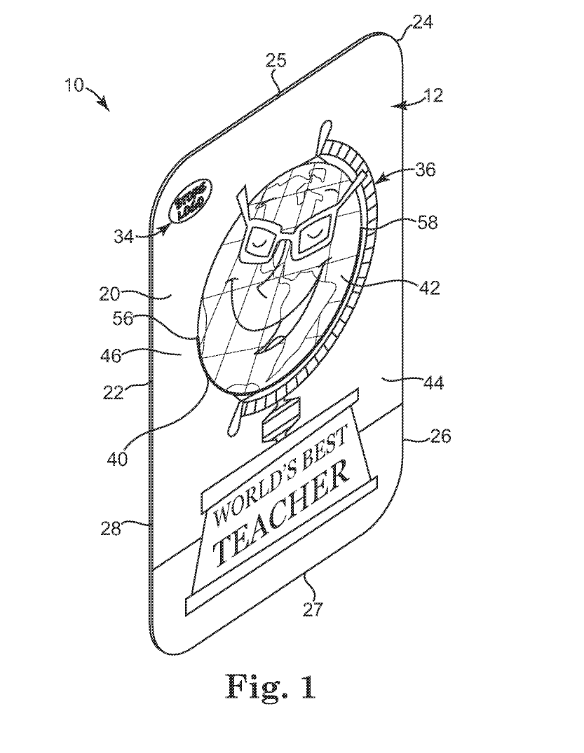

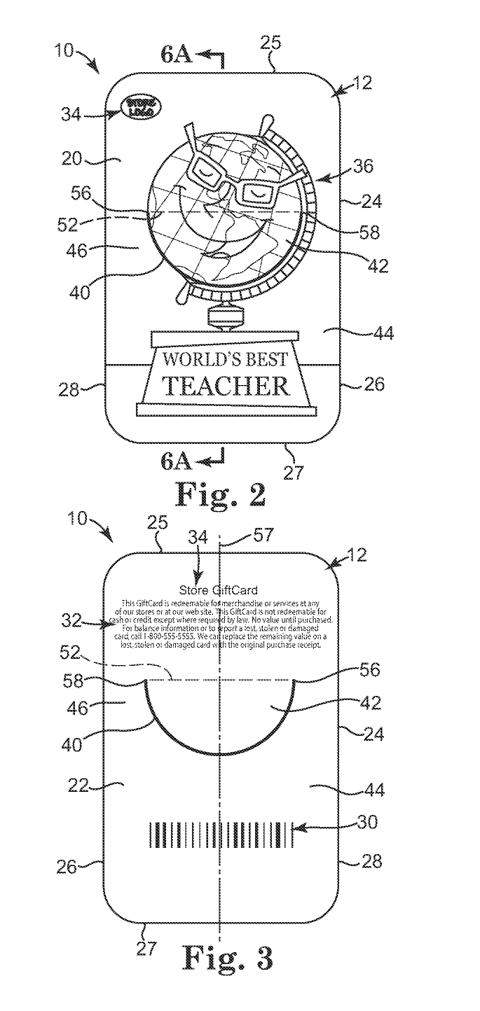

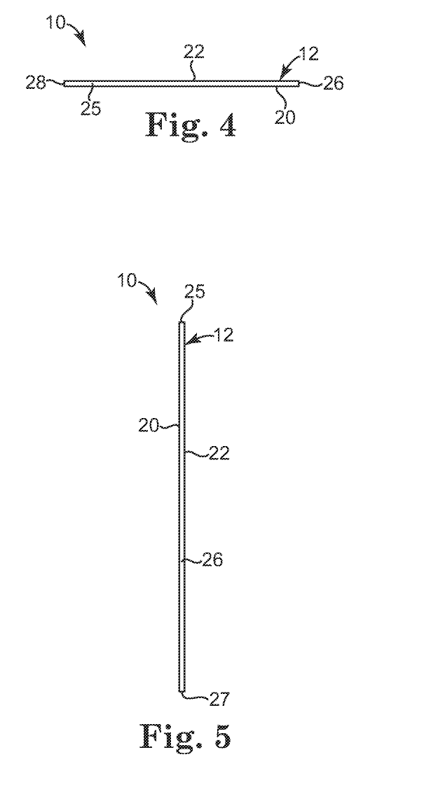

Turning to the figures, FIGS. 1-6B illustrate various views of one embodiment of a stored-value product or card 10 formed of a substrate 12. Substrate 12 is any suitable material such as a somewhat rigid yet flexible material similar to that commonly used for identification cards, credit cards, etc. More specifically, in one embodiment, substrate 12 is a substantially planar member formed of paper, cardstock, plastic, e.g. polycarbonate, polystyrene, polyvinyl chloride (PVC), or other suitable material. In one embodiment, substrate 12 is formed of injection molded plastic or cut from sheet-stock plastic material. Substrate 12 can be formed in any other suitable planar or non-planar configuration as will be apparent to those of skill in the art upon reading this application.

Substrate 12 defines a first surface 20 (i.e., a first major surface) and a second surface 22 (i.e., a second major surface) opposite first surface 20. In one embodiment, at least one of first and second surfaces 20 and 22 is substantially planar. In one embodiment, substrate 12 is formed with a substantially rectangular shaped perimeter 24, and, in one example, is similarly sized to an identification card, a credit card, or other card sized to fit in a wallet of a card bearer (i.e. is wallet sized). In particular, in one embodiment, the overall dimensions of substrate 12 are about 8.5 cm by about 5.5 cm wide with a thickness of less than about 1 mm. As such, perimeter 24 is collectively defined by a first or top edge 25, a second or side edge 26, a third or bottom edge 27, and a fourth or side edge 28. In other embodiments, substrate 12, and therefore, perimeter 24, is otherwise shaped as a square, circle, oval, star, or any other suitable shape.

Referring to the rear view illustration of FIG. 3, stored-value card 10, for example, second surface 22 of substrate 12, includes at least one account activation area or account identifier 30, such as a bar code, a magnetic strip, a smart chip or other electronic device, a radio frequency identification (RFID) device, or other suitable identifier readily readable by a point-of-sale terminal, account access station, kiosk, or other suitable device. More particularly, in one embodiment, account identifier 30 is printed on or otherwise applied to second surface 22 of substrate 12. Account identifier 30 indicates a financial or other stored-value account or record to which stored-value card 10 is linked. The account or record of the monetary, points, minutes, or other balance associated with stored-value card 10 optionally is maintained on a database, other electronic or manual record-keeping system, or, in the case of “smart” cards for example, on a chip or other electronic device on/in stored-value card 10 itself. Accordingly, by scanning account identifier 30, the account or record linked to stored-value card 10 is identified and can subsequently be activated, have amounts debited therefrom, and/or have amounts credited thereto. Account identifier 30 is one example of means for linking stored-value card 10 with an account or record.

In one embodiment, redemption indicia 32 are included on stored-value card 10 such as on second surface 22 of substrate 12. Redemption indicia 32 indicate that stored-value card 10 is redeemable for the purchase of goods and/or services and that, upon use, a value of the purchased goods and/or services will be deducted from the account or record linked to stored-value card 10. In one embodiment, redemption indicia 32 include phrases such as “<NAME OF STORE> GiftCard” and “This GiftCard is redeemable for merchandise or services at any of our stores or at our website,” and/or provides help or phone line information in the case of a lost, stolen, or damaged stored-value card, etc.

In one embodiment, stored-value card 10 includes other indicia disposed on stored-value card 10 such as, for example, brand indicia 34 and decorative indicia 36. Brand indicia 34 include, a logo, text, trademark etc. that associates stored-value card with at least one of a product, a brand, a store, etc. Decorative indicia 36 include any item (e.g., graphics or text) depicting or relating to, for example, any one or more of a holiday, a season, an occasion, a media format, e.g. characters, logos, scenes, or other illustrations or photographs related to at least one of a movie, television show, book, video game, etc. Other indicia or additional features may also be included on stored-value card 10 as will be apparent to those of skill in the art upon reading this application. In one example, any one or more of indicia 32, 34, and 36 may not be included on stored-value card 10.

A slit or cut 40 is defined and extends entirely through substrate 12 (i.e., through first surface 20 and second surface 22). In one embodiment, cut 40 is curvilinear or otherwise formed to define a tab or first portion 42. More specifically, cut 40 defines at least part of a boundary between first portion 42 and a remainder or second portion 44 of substrate 12. In one embodiment, cut 40 and first portion 42 are substantially symmetrical about a vertical centerline 57 (FIG. 3) of substrate 12. First portion 42 is at least partially deflectable away from second portion 44 of substrate 12. In one embodiment, cut 40 is fully formed within an interior 46 of substrate 12 and does not extend to perimeter 24. Cut 40 is one example of means for dividing substrate 12 into a first portion 42 and a second portion 44.

First portion 42 can be defined in any suitable configuration. In one example, first portion 22 is substantially centered between side edges 26 and 28 of substrate 12 and/or is positioned nearer top edge 25 than bottom edge 27. In one example, first portion 22 has a height of less than a quarter of a height of substrate 12 (e.g., the distance between top edge 25 and bottom edge 27) and/or has a width that is at least two-thirds a width of substrate 12 (e.g., the distance between side edges 26 and 28). Other suitable positions and proportions of substrate 12 and cut 40 will be apparent to those of skill in the art upon reading this application.

In one example, decorative indicia 36 are positioned to correspond with cut 40. For example, where cut 40 is semicircular, cut 40 may follow a perimeter or other portion of an at least partially round item (e.g., text or graphic), such as a globe as depicted in FIGS. 1-7. Other suitable graphics corresponding to cut 40 will be apparent to those of skill in the art upon reading this application.

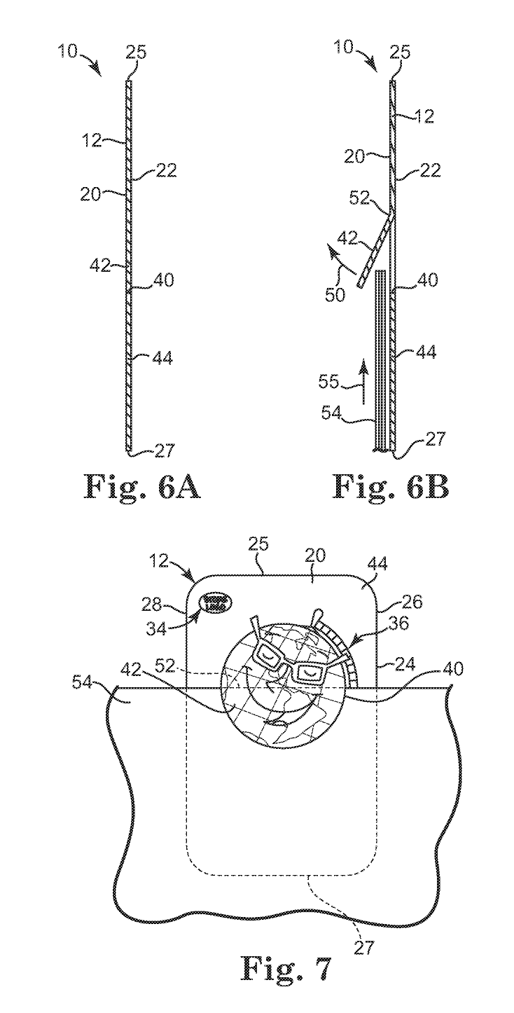

Cut 40 configures stored-value card 10 for use a bookmark. More specifically, referring to the cross-sectional view of FIGS. 6A and 6B, upon application of a force (generally indicated at 50 in FIG. 6B) to first portion 42, first portion 42 moves (e.g. flexes, deflects, rotates, etc.) from a first position as shown in FIG. 6A to a second position as shown in FIG. 6B. In one example, first portion 42 is substantially coplanar with second portion 44 when in the first position and is deflected, flexed, or rotated generally about a flexure line 52 (generally indicated in dashed lines) away from second portion 44 when in the second position. More specifically, first portion 42 is deflected away from second portion 44, and one or more page or sheets of paper 54 are moved relative to stored-value card 10 (e.g., by moving one or both of stored-value card 10 and sheets of paper 54) in a direction as generally indicated with directional arrow 55 in FIG. 6B. In one example, when in the second position, first portion 42 is deflected outwardly beyond a portion of first surface 20 that is defined by second portion 44. As such, pages 54 of a book, periodical, etc. can be received between first portion 42 and second portion 44, more particularly, between second surface 22 of first portion 42 and first surface 20 of second portion 44.

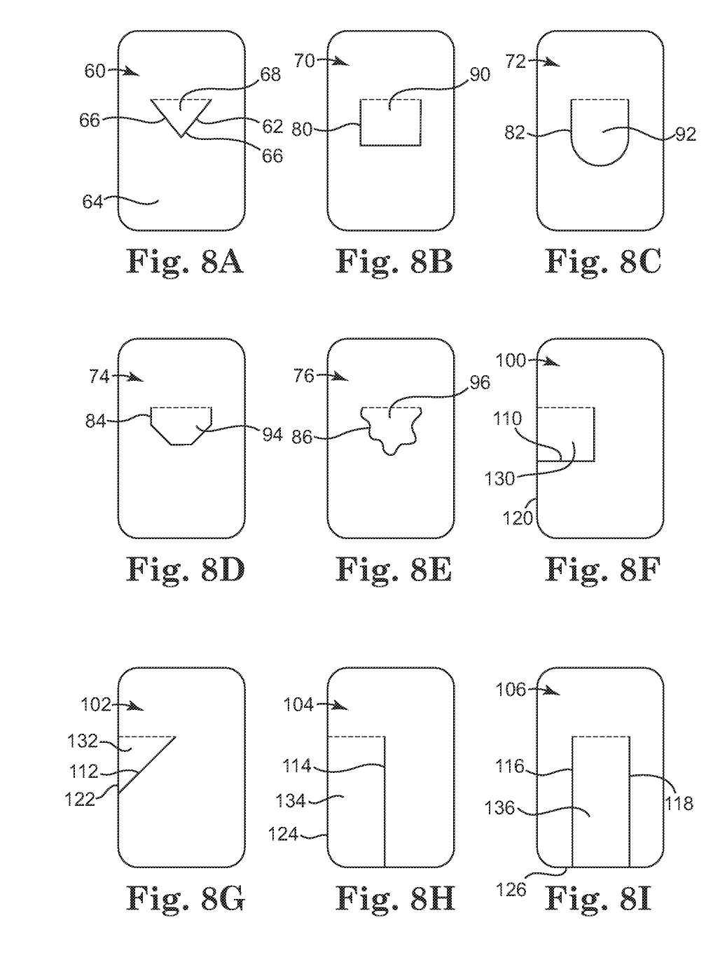

Cut 40 defines a first cut end 56 and a second cut end 58, and flexure line 52 extends between first cut end 56 and second cut end 58. In one example, each of first cut end 56 and second cut end 58 are positioned a similar distance perpendicularly downward from top edge 25 such that flexure line 52 extends substantially parallel to top edge 25 and, in one embodiment, substantially perpendicular to side edges 26 and 28. In one example, boundaries of first portion 42 are entirely defined by cut 40 and flexure line 52. In one embodiment, perimeter 24 also defines a boundary section of first portion 42 (e.g., FIGS. 8F-8I).

In one embodiment, first portion 42 is biased toward the first position (e.g. to be substantially coplanar with second portion 44), and therefore, upon removal of force 50, first portion 42 moves back toward the first position. As a result, pages 54 are selectively secured (e.g., clasped, wedged, etc.) between first portion 42 and second portion 44. In this manner, stored-value card 10 is secured relative to pages 54 and is less likely to be inadvertently removed from a position within the respective book, periodical, etc., thereby decreasing the likelihood that a user will inadvertently lose their marked page in the book.

Cuts or slits shaped differently than cut 40 are also contemplated. For example, as illustrated in FIGS. 8A-8E, differently shaped cuts can be formed in an interior portion of a respective stored-value card as will be apparent to those of skill in the art upon reading this application. More specifically, FIG. 8A illustrates a stored-value card 60 with a triangular shaped cut 62 fully defined in an interior portion 64 thereof. As such, cut 62 includes two substantially linear segments 66 defining a tab or first portion 68 of stored-value card 60 therebetween. FIGS. 8B, 8C, 8D, and 8E define stored-value cards 70, 72, 74, and 76, respectively, each defining a differently shaped fully interior cut 80, 82, 84, or 86 having one or more of linear, curvilinear, or otherwise shaped line segments. More specifically, cut 80 defines a substantially rectangular first portion 90, cut 82 defines a substantially oblong first portion 92, cut 74 defines a partial polygon-shaped first portion 94, and curvilinear cut 76 defines a generally amebic-shaped first portion 96.

FIGS. 8F-8I each illustrate a stored-value card 100, 102, 104, or 106, respectively, with one or more cuts 110, 112, 114, 116, and/or 118 that each extend to a corresponding stored-value card perimeter 120, 122, 124, and 126. In this manner, a first portion 130, 132, 134, or 136 is defined by a respective stored-value card perimeter 120, 122, 124, and 126 and cut(s) 110, 112, 114, 116, and/or 118. Similar to first portion 42 (FIGS. 1-7), first portions 68, 90, 92, 94, 96, 130, 132, 134, and 136 are each configured to rotate or otherwise deflect from remainders of stored-value cards 60, 70, 72, 74, 76, 100, 102, 104, and 106 to receive pages 54 therebetween. As illustrated, the one or more cuts may be substantially symmetrically formed about a center line of the respective stored-value card (e.g., cuts 62, 80, 82, and 84 or cuts 116 and 118) or may be substantially asymmetrically formed about a center line of the stored-value card (e.g., cuts 86, 110, 112, and 114). Although the remainder of this application primarily refers to stored-value card 10, it should be understood that any of stored-value cards 60, 70, 72, 74, 76, 100, 102, 104, and 106 or similar stored-value cards may generally be substituted as will be apparent to those of skill in the art upon reading the present application.

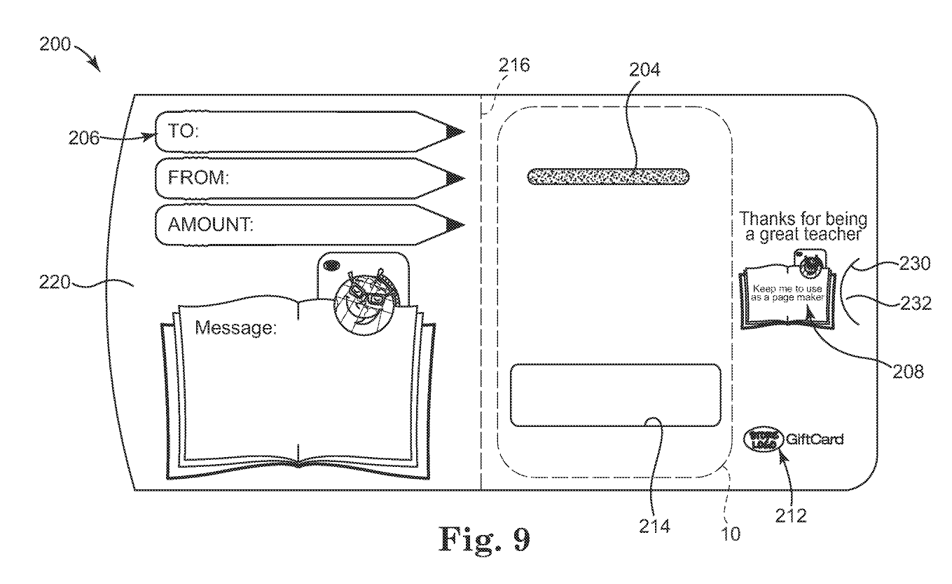

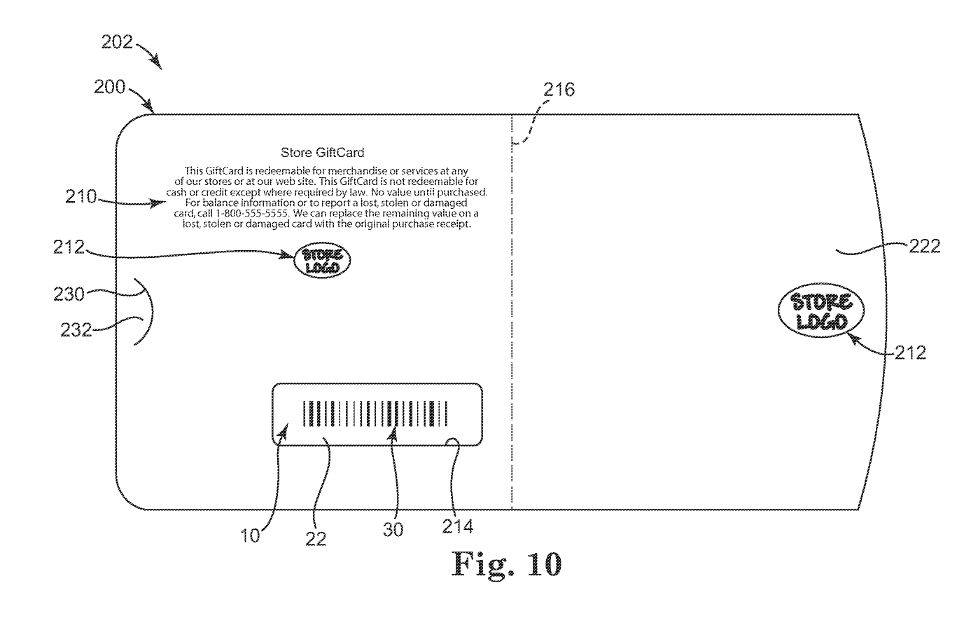

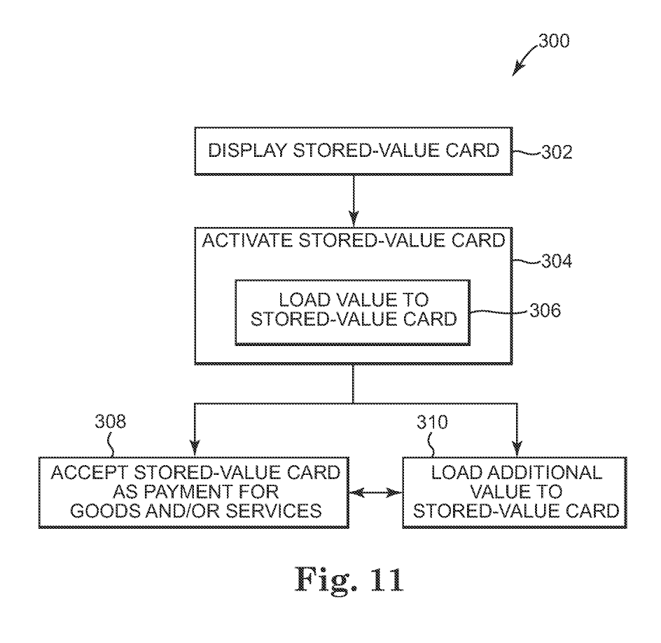

FIGS. 9 and 10 illustrate a carrier or backer 200 for supporting stored-value card 10. Stored-value card 10, which is represented in phantom lines in FIG. 9 for illustrative purposes so as to not obstruct backer 200, is readily releasably attached to backer 200, for example by a removable adhesive 204 or the like. Backer 200 and stored-value card 10 collectively define a stored-value card assembly 202 (FIG. 10). Backer 200 comprises a single layer or multiple layers of paper or plastic material, for example, generally in the form of a relatively stiff but bendable/flexible card. Use of other materials is also contemplated. Backer 200 displays indicia, graphics or text information including store logo(s), store name(s), slogans, advertising, instructions, directions, brand indicia, promotional information, holiday indicia, seasonal indicia, media format identifiers, characters, and/or other information.

For example, indicia 206 include to, from, amount, and message fields. The fields of indicia 206 provide areas of backer 200 configured to be written upon by a consumer to personalize backer 200 for presentation as a gift to a particular recipient, for a particular purpose, and/or to indicate a value of stored-value card 10. In one example, indicia 208 promote that stored-value card 10 functions as a bookmark. In one instance, indicia 208 state “Keep me to use as a page marker.” In one example, indicia 208 additionally instruct the bearer of store-value card 10 on how to use stored-value card 10 for amusement.

Referring to FIG. 10, in one embodiment, indicia 210 indicate that stored-value card 10 is redeemable for the purchase of goods and/or services and that upon use, a value of the purchased goods and/or services will be deducted from the financial account or record linked to stored-value card 10. In one embodiment, indicia 210 include phrases such as “<NAME OF STORE> GiftCard” and “This GiftCard is redeemable for merchandise or services at any of our stores or at our website,” and/or provides help or phone line information in case of a lost, stolen, or damaged stored-value card 10, etc.

Brand indicia 212 may also or alternatively be included to identify a store, brand, department, etc. and/or services associated with stored-value card 10. Any of indicia 32, 34, 36, 206, 208, 210, 212, or other indicia optionally may appear anywhere on backer 200 or stored-value card 10. Additional information besides that specifically described and illustrated herein may also be included and/or one or more of indicia 32, 34, 36, 206, 208, 210, and 212 may be eliminated.

Backer 200 includes a window or opening 214 for displaying account identifier 30 of stored-value card 10 therethrough as illustrated in FIG. 10. As previously described, account identifier 30 is adapted for accessing an account or a record associated with stored-value card 10 for activating, loading value to, or debiting value from the account or record. Accordingly, opening 214 allows viewing or other access to account identifier 30 to activate and/or load stored-value card 10 without removing stored-value card 10 from backer 200. In one embodiment, a portion of backer 200 alternatively is configured to be folded away from the remainder of backer 200 to access account identifier 30 without removing stored-value card 10 from backer 200.

In one embodiment, backer 200 is a bi-fold substrate defining a fold line 216, about which backer 200 is foldable roughly in half. In FIGS. 9 and 10, backer 200 is unfolded, i.e. is in an open configuration. According to one embodiment, FIG. 9 illustrates inside surfaces 220 of backer 200 that will be supported on a rack or other fixture to be visible to a consumer of a retail store who is considering the purchase of stored-value card 10. In another example, while on display in a retail store, backer 200 is folded back about fold line 216 to present only portions of inside surfaces 220 of backer 200, i.e., surfaces illustrated in FIG. 9, that are positioned on the same side of fold line 216 as stored-value card 10 to a consumer. In such an embodiment, indicia 206 would not be visible to a consumer when backer 200 and stored-value card 10 are placed for display in a retail store. Backer 200 is one example of means for supporting stored-value card 10 for display in a retail setting.

After purchase, backer 200 is foldable about fold line 216 such that inside surfaces 220 (FIG. 9) of backer 200 are folded toward each other and stored-value card 10 is enclosed or wrapped in a compact package formed by foldable backer 200. In this manner, outer surfaces 222 (FIG. 10) of backer 200 are disposed toward the outside of the folded, compact package, according to embodiments of the invention. In one embodiment, folded backer 200 effectively wraps stored-value card 10 for presentation from a consumer to a recipient. Folding backer 200 in the other direction about fold line 216 for display on a rack in a retail setting, or about other fold lines of backer 200 is also contemplated. In one embodiment, although described above and depicted in FIGS. 9 and 10 as a single fold line 216, fold line 216 may be one of a plurality of fold lines (not shown) so as to accommodate various thickness of or to otherwise wrap stored-value card 10 as will be apparent to those of skill in the art upon reading this application.

In one embodiment, a cut 230 is formed through backer 200 near an edge of backer 200 spaced from and substantially parallel to fold line 216. Cut 230 extends partially toward fold line 216 and defines a flap 232, which can be partially bent away from the remainder of backer 200. More specifically, upon folding of backer 200 about fold line 216 to close backer 200 around stored-value card 10, an opposing edge of backer 200 is tucked beneath flap 232 to maintain backer 200 in a folded or closed position. In one embodiment, cut 230 and thereby flap 232 are each substantially semi-circular in shape. Other backers similar to backer 200 can be used having various sizes and shapes for supporting stored-value card 10.

FIG. 11 is a flow chart illustrating one embodiment of a method 300 of encouraging purchase and facilitating use of stored-value card 10 (or one of stored-value cards 60, 70, 72, 74, 76, 100, 102, 104, and 106 as will be apparent to those of skill in the art) by consumers and/or recipients. Although the remainder of this application primarily refers to stored-value card 10, it should be understood that any of stored-value cards 60, 70, 72, 74, 76, 100, 102, 104, and 106 or similar stored-value cards may generally be substituted therefore, as will be apparent to those of skill in the art upon reading the present application.

At 302, stored-value card 10 is placed or hung from a rack, shelf, or other similar device to display stored-value card 10 for sale to potential consumers. For example, outside surfaces 222 of backer 200 may be folded about fold line 216 toward one another and stored-value card assembly 202 (FIGS. 9 and 10) placed on a display rack such that stored-value card 10 is readily visible to potential consumers. In one embodiment, a depiction of stored-value card 10 is placed on a website for viewing and purchase by potential consumers.

At 304, a consumer who has decided to purchase stored-value card 10 presents the stored-value card 10 on backer 200 to a retail store employee, retail store kiosk, remote terminal, or other person or device to scan account identifier 30 to access an account or record linked to account identifier 30. In particular, account identifier 30 is scanned or otherwise accessed, for example through opening 214 of backer 200 to activate stored-value card 10. Upon accessing the account or record, then, at 306, value is added to the account or record in the form of monetary value, points, minutes, etc. Thus, stored-value card 10 is activated and loaded.

Once stored-value card 10 is activated and loaded, stored-value card 10 can be used by the consumer or any other bearer of stored-value card 10 to purchase goods and/or services at the affiliated retail setting (e.g., a retail store or website) or can be used in exchange for calling minutes, etc. In one embodiment, where stored-value card 10 is displayed on a website at 302, then, at 304, stored-value card 10 may be activated in any suitable method and may not require the physical scanning of account identifier 30 to be activated or to otherwise access the associated account or record such as at 306.

In one example, at 308, the retail store or other affiliated retail setting or website accepts stored-value card 10 as payment towards the purchase of goods and/or services made by the current bearer of stored-value card 10. In particular, the value currently loaded on stored-value card 10 (i.e. stored or recorded in the account or record linked to account identifier 30) is applied toward the purchase of goods and/or services. At 310, additional value is optionally loaded on stored-value card 10 at a point of sale terminal, kiosk, or other area of the retail store or related setting. Upon accepting stored-value card 10 as payment at 308, the retail store or related setting can subsequently perform either operation 308 or operation 310 as requested by a current bearer of stored-value card 10. Similarly, upon loading additional value on stored-value card 10 at 310, the retail store or related setting can subsequently perform either operation 310 again or operation 308. In one example, the ability to accept stored-value card 10 as payments for goods and/or services is limited by whether the account or record associated with stored-value card 10 has any value stored or recorded therein at the time of attempted redemption.

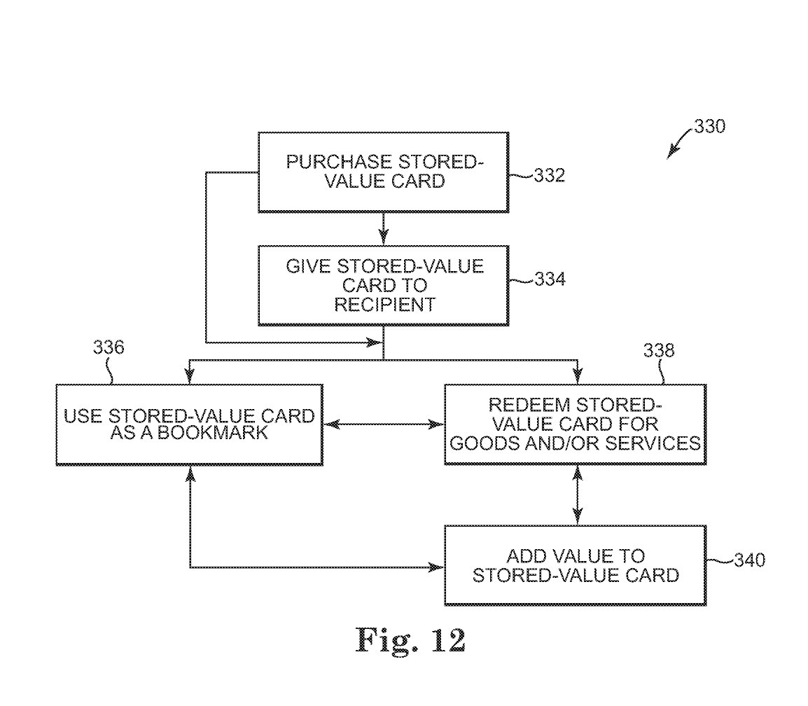

FIG. 12 is a flow chart illustrating one embodiment of a method 330 of using stored-value card 10 (e.g., FIGS. 1-7). At 332, a potential consumer of stored-value card 10, which is displayed in a retail store or viewed on a website, decides to and does purchase stored-value card 10 from the retail store or website. Stored-value card 10 can be displayed and purchased alone or as part of stored-value card assembly 202 (FIG. 10) along with backer 200. Upon purchasing a stored-value card 10, a retail store employee, a retail store kiosk, or other person or device scans account identifier 30 (FIGS. 3 and 10) through opening 214 of backer 200 or otherwise reads or accesses account identifier 30. Upon accessing account identifier 30, the account or record linked to account identifier 30 is accessed and activated to load value onto stored-value card 10. In one embodiment, such as where stored-value card 10 is purchased at 332 via a website, actual scanning of account identifier 30 may be eliminated.

At 334, the consumer optionally gives stored-value card 10 to a recipient, such as a graduate, relative, friend, expectant parents, one having a recent or impending birthday, a couple having a recent or impending anniversary, etc. In one embodiment, a plurality of stored-value cards 10 are purchased and given to party goers, such as at a birthday party, etc. as party favors or gifts. As an alternative, the consumer can keep stored-value card 10 for his or her own use thereby eliminating operation 334.

At 336, the consumer or recipient, whoever is in current ownership or otherwise is the current bearer of stored-value card 10, removes stored-value card 10 from backer 200 and uses stored-value card 10 as a bookmark. For example, the current bearer of stored-value card 10 secures pages 54 between first portion 42 and second portion 44 of stored-value card 10.

At 338, the consumer or recipient redeems stored-value card 10 for goods and/or services from the retail store or website. At 340, the consumer or recipient of stored-value card 10 optionally adds value to first portion 42 of stored-value card 10, and more particularly, to the account or record associated with account identifier 30 included therewith, at the retail store or over the Internet (i.e. via the website). Upon using stored-value card 10 as a bookmark at 336, redeeming stored-value card 10 at 338, or adding value to stored-value card 10 at 340, the consumer or recipient of stored-value card 10 subsequently can perform any of operations 336, 338, or 340 as desired. In one embodiment, the ability of the consumer or recipient to repeat redeeming stored-value card 10 at 338 is limited by whether the account or record linked with stored-value card 10 has any remaining value stored or recorded therein at the time of attempted redemption.

Although described above as occurring at a single retail store or website, in one embodiment, purchasing stored-value card 10 at 332, redeeming stored-value card 10 at 338, and adding value to stored-value card 10 at 340, can each be performed at any one of a number of stores adapted to accept stored-value card 10 or over the Internet. In one example, a number of stores are each part of a chain or are similarly branded stores. In one example, a number of stores include at least one website and/or at least one conventional brick and mortar store.

Stored-value cards come in many forms, according to embodiments of the invention. The gift card, like other stored-value cards, can be “re-charged” or “re-loaded” at the direction of the original consumer, the gift recipient, or third party. The term “loading on” or “loaded on” herein should be interpreted to include adding to the balance of an account or record associated with a stored-value card. The balance associated with the stored-value card declines as the card is used, encouraging repeat visits or use. The card remains in the user's purse or wallet, serving as an advertisement or a reminder to revisit the associated merchant. Gift cards according to embodiments of the invention provide a number of advantages to both the consumer and the merchant. Other gift cards and stored-value cards according to embodiments of the invention include loyalty cards, merchandise return cards, electronic gift certificates, calling cards, employee cards, frequency cards, prepaid cards, and other types of cards associated with or representing purchasing power or monetary value, for example.

Although the invention has been described with respect to particular embodiments, such embodiments are meant for illustrative purposes only and should not be considered to limit the invention. Various alternatives and changes will be apparent to those of ordinary skill in the art. Other modifications within the scope of the invention and its various embodiments will be apparent to those of ordinary skill.

What is claimed is:

1. A financial transaction card comprising:
a substrate including an account identifier linking the financial transaction card to at least one of a financial account and a financial record, the account identifier being machine readable by a point-of-sale terminal;
a cut formed through the substrate to define a boundary between a first portion and a second portion of the substrate,
wherein the first portion of the substrate is configured to flex relative to the second portion of the substrate, and the first portion is biased toward the second portion such that the financial transaction card is configured to receive and secure one or more sheets of paper between the first portion and the second portion of the substrate.

2. The financial transaction card of claim 1, wherein the account identifier includes a bar code.

3. The financial transaction card of claim 1, wherein the account identifier includes at least one of a bar code, a magnetic strip, an electronic device, and a radio frequency identification (RFID) device.

4. The financial transaction card of claim 1, wherein the substrate is substantially planar.

5. The financial transaction card of claim 1, wherein the cut is formed entirely within an interior of the substrate.

6. The financial transaction card of claim 1, wherein the cut extends to a perimeter of the substrate.

7. The financial transaction card of claim 1, wherein the cut defines a first cut end and a second cut end, and a flexure line generally extends between the first cut end and the second cut end.

8. The financial transaction card of claim 7, wherein the flexure line is substantially parallel to a top edge of the substrate.

9. The financial transaction card of claim 1, wherein the cut is substantially symmetrical about a centerline of the substrate.

10. The financial transaction card of claim 1, wherein the cut follows a perimeter of an item depicted on a first major surface of the substrate.

11. The financial transaction card of claim 1, wherein the substrate defines a first major surface and a second major surface opposite the first major surface, the second major surface including the account identifier, wherein the first portion of the substrate deflects outwardly beyond a portion of the first major surface defined by the second portion of the substrate.

12. The financial transaction card of claim 1, in combination with a backer selectively coupled with and configured to support the financial transaction card.

13. The combination of claim 12, wherein the backer defines a window, wherein the substrate is coupled to the backer such that the account identifier is viewable through the window of the backer.

14. A stored-value card comprising:
a substantially planar member;
means for dividing the substantially planar member into a tab and primary portion, wherein the tab is configured to deflect relative to the primary portion to receive and maintain one or more pages between the tab and the primary portion; and
means for linking the stored-value card to a stored-value account or record.

15. The stored-value card of claim 14, wherein the means for dividing intersects a perimeter of the substantially planar member.

16. The stored-value card of claim 14, wherein the tab is substantially semicircular in shape.

17. The stored-value card of claim 14, in combination with means for supporting the stored-value card for display, wherein the means for supporting includes means for permitting access to the means for linking through the means for supporting.

18. A method of encouraging purchase and facilitating use of a stored-value card, the method comprising:
displaying the stored-value card such that a slit formed in the stored-value card is visible, the slit at least partially defining a first portion and a second portion of the stored-value card, wherein the first portion is moveable relative to the second portion of the stored-value card to clasp a sheet of a publication between the first portion and the second portion of the stored-value card such that the stored-value card functions as a bookmark, and wherein the stored-value card includes an activation area linking the stored-value card to a stored-value account or record;
visually indicating that the stored-value card functions as a bookmark; and
activating the stored-value card to permit deductions from the stored-value account or record including machine reading the activation area to determine the stored-value account or record linked to the stored-value card.

19. The method of claim 18, wherein displaying the stored-value card includes displaying the stored-value card coupled to a carrier, which supports the stored-value card.

20. The method of claim 18, further comprising receiving the stored-value card as payment for goods or services, at least a portion of a value of the goods or services being deducted from the stored-value account or record.
